(19) United States
(12) Patent Application Publication
(10) Pub. No.: US 2025/0069166 A1
(43) Pub. Date: Feb. 27, 2025

(54) INTEGRATED OPERATION METHOD AND SYSTEM FOR PORT-AND-SHIP ENERGY AND TRANSPORTATION SYSTEM BASED ON LAYERED GAME

(71) Applicant: SHANGHAI JIAO TONG UNIVERSITY, Shanghai (CN)

(72) Inventors: Shuli WEN, Shanghai (CN); Anni LIN, Shanghai (CN); Miao ZHU, Shanghai (CN); Sheng JIANG, Shanghai (CN); Zhixing DONG, Shanghai (CN); Huili YE, Shanghai (CN); Chunyang PAN, Shanghai (CN); Liting XU, Shanghai (CN); Jianjun MA, Shanghai (CN)

(73) Assignee: SHANGHAI JIAO TONG UNIVERSITY, Shanghai (CN)

(21) Appl. No.: 18/722,624

(22) PCT Filed: Feb. 24, 2023
(86) PCT No.: PCT/CN2023/078052

§ 371 Date: Jun. 21, 2024

(30) Foreign Application Priority Data
Feb. 24, 2022 (CN) 202210175637.9

(51) Int. Cl. G06Q 50/06; G06Q 10/0835

(52) U.S. Cl. CPC G06Q 50/06; G06Q 10/08355

(57) ABSTRACT

The method includes: S1: formulating a layered game architecture for a port-and-ship integrated energy and transportation operation; S2: establishing a port-and-ship layered game optimization model based on an optimized objective function and an optimized constraint condition of a port and an optimized objective function and an optimized constraint condition of a ship; and S3: based on the port-and-ship layered game optimization model, solving, by the layered game architecture, an optimal integrated operation method for the port-and-ship energy and transportation system through a KKT (Karush-Kuhn-Tucker) optimality condition solving method. The port-and-ship layered game optimization model means that the port, as a superior guider, formulates and executes a strategy, the ship, as an inferior follower, makes corresponding responses by taking the strategy formulated by the port as a constraint, and the ship updates its strategy according to the responses made by the ship till reaching a game equilibrium.

### CROSS REFERENCE TO THE RELATED APPLICATIONS

This application is the national phase entry of International Application No. PCT/CN2023/078052, filed on Feb. 24, 2023, which is based upon and claims priority to Chinese Patent Application No. 202210175637.9, filed on Feb. 24, 2022, the entire contents of which are incorporated herein by reference.

### TECHNICAL FIELD

The present invention relates to the technical field of optimized operations of integrated port-and-ship energy and transportation systems, particularly relates to an integrated operation method for a port-and-ship energy and transportation system based on a layered game, and more particularly relates to an integrated operation method and system for a port-and-ship energy and transportation system based on a layered game theory.

### BACKGROUND

A port, as an important hub linking a sea and a land, undertakes key tasks such as logistics transportation. Ships are the most significant service objects in a port energy system, and berthing service management and charging and discharging optimized management of the port energy system are an effective means to achieve the overall operating economy of the port and ships.

To encourage energy interaction between the ships and the port, a marine energy and service transaction mechanism is established to achieve energy transaction and service management of a ship mobile microgrid and a port micro energy grid. In an energy market transaction model, the port, as an energy agent, participates in electric energy declaration and transaction on the public power market and sets a current energy transaction price between the port and the ships. In a marine berth service transaction model, the port sets a ship berth service price based on historical ship berth service data. Based on a layered principal and subordinate game model, the port energy agent sets the reasonable energy transaction price and the berth service price to guide the ships to berth orderly, thereby achieving the overall operating economy of the port and the ship by means of coordinated scheduling.

In a logistics-energy cooperative optimized scheduling method for a large harbor comprehensive energy system written by Huang Yiwen, Huang Wentao, Weiwei, Tai Nengning, and Li Ran in the Proceedings of the CSEE 1-12[2021 Dec. 22], to achieve energy conservation and emission reduction and energy efficiency improvement of the port, provided is a logistics-energy cooperative optimized scheduling method for a harbor comprehensive energy system to fully excavate the economic optimizing potential of combination of a logistics system and an energy system. From the perspective of operating characteristics of the logistics system, the influence of quay crane scheduling on the in-port state of the ship, and a port-and-ship logistics cooperative scheduling model is established. By analyzing the energy consumption characteristics of the harbor logistic system, in combination with the in-port state and the loaded operating characteristics of the ship, a coupled load model of a logistics-energy system is established to achieve cooperation between the logistics system and the energy system. Targeted at the lowest operating cost, in combination with various energy utilization forms, the harbor logistics-energy coupled system is cooperatively optimized to obtain a ship load operating strategy, a quay crane scheduling solution, and outputs of energy equipment. By taking a harbor in Shanghai as an example, a simulation result shows that the mentioned method is capable to effectively combine the logistics system and the energy system of the port, reduce the operating cost and the carbon emission, and improve the comprehensive energy utilization ratio on a basis of fully considering scheduling of the ships. The document provides a logistics-energy cooperative optimized scheduling strategy for a harbor comprehensive energy system. With a view to the economy and environmental protection property of the comprehensive harbor energy system, the method does not take the energy transaction mechanism between the ships and the port into consideration. In addition, in the document, dynamic responses of the ships to the energy transaction price and the berth service price in the optimized decision of the port are not considered.

In a comprehensive port energy system (II): flexible resources and key technologies in energy-transportation integration for carbon neutrality [J/OL] in the Proceedings of the CSEE: 1-20[2021 Dec. 22] written by Fang Sidun, Zhao Changhong, Ding Zhaohao, Zhang Shenxi, and Liao Ruijin, the comprehensive port energy system is the mark of transportation-energy fused development. As a second part of a thesis, the flexible resources in energy-transportation integration of the port are analyzed first from an energy side and a transportation side in this thesis, and a modeling method of the flexible resources is provided. Then, based on the research on a current comprehensive land energy system, an energy-logistics modeling method of the port comprehensive energy system is expected in this thesis. Finally, in combination with current research status, the following three future key technologies are provided: an energy-transportation integrated planning method, an energy-transportation integrated operating method, and an energy-transportation integrated evaluation index system. The document summarizes the key technologies of the port-and-ship integrated system without specific technical solutions and the energy transaction mechanism between the port and the ships.

F. D. Kanellos, “Multiagent-System-Based Operation Scheduling of Large Ports'Power Systems With Emissions Limitation,” in IEEE Systems Journal, vol. 13, no. 2, pp. 1831-1840 June 2019, doi: 10.1109/JSYST.2018.2850970. The document provides a multiagent-system-based method for optimized operation of a large port, with a view to the economy and the environmental protection property of the port itself without considering the energy transaction strategy optimization between the port and the ships.

A patent literature CN113822578A (Application No. 202111117258.6) discloses a distributed energy management method cooperatively considering a port-and-ship comprehensive energy system. During the period when the ships depart from the port, energy is managed within the port comprehensive energy system. During the period when the ships approach the shore and reach the port to stay, the ships are regarded as mobile power supplies and serve as extra power supply devices which participate in the port comprehensive energy system, so that the energy is fully utilized. The present invention solves the energy management problem for the centralized energy management mode during ship navigation based on a dynamic programming method. The distributed energy management mode based on the port comprehensive energy system during ship navigation and the cooperatively considered ship-and-port comprehensive energy system mode during the period when the ships reach the port are optimally scheduled by using a distributed alternating multiplier algorithm.

### SUMMARY

To overcome deficiencies in the prior art, an object of the present invention is to provide an integrated operation method and system for a port-and-ship energy and transportation system based on a layered game.

The integrated operation method for a port-and-ship energy and transportation system based on a layered game provided by the present invention includes:
S1: formulating a layered game architecture for a port-and-ship integrated energy and transportation operation;
S2: establishing a port-and-ship layered game optimization model based on an optimized objective function and an optimized constraint condition of a port and an optimized objective function and an optimized constraint condition of a ship; and
S3: based on the port-and-ship layered game optimization model, solving, by the layered game architecture, an optimal integrated operation method for the port-and-ship energy and transportation system through a KKT (Karush-Kuhn-Tucker) optimality condition solving method;

where the port-and-ship layered game optimization model means that the port, as a superior guider, formulates and executes a strategy, the ship, as an inferior follower, makes corresponding responses by taking the strategy formulated by the port as a constraint, and the ship updates its strategy according to the responses made by the ship till reaching a game equilibrium.

Preferably, step S1 uses:

$$G = \{ ( P ⋃ S ) ; {s}_{p} ; {F}_{p} ; {s}_{s} ; {F}_{s} \} \qquad ( 1 )$$

where P represents energy supply equipment of the port; S represents a ship set; Sₚ represents a strategy set of a fixed microgrid of the port; Sₛ represents a strategy set of a mobile microgrid of the ship; Fₚ represents a net income realized by the strategy set of the fixed microgrid of the port; and Fₛ represents a net income realized by the strategy set of the mobile microgrid of the ship;

when the game reaches equilibrium, a utility function shall satisfy:

$${F}_{p} ( {s}_{p}^{*} , {s}_{s}^{*} ) \geq {F}_{p} ( {s}_{p} , {s}_{s}^{*} ) \qquad ( 2 )$$

$${F}_{s , i} ( {s}_{p}^{*} , {s}_{s , i}^{*} ) \geq {F}_{s , i} ( {s}_{p}^{*} , {s}_{s , ( - i )}^{*} , {s}_{s , i} )$$

where F_{s,i} is the utility function of an i^{th} ship; and S*_{s,(-i)} is a charging and discharging strategy set of other ships.

Preferably, the strategy set Sₚ of the fixed microgrid of the port comprises active S outputs of energy supply equipment, a price of electricity sold by the port to the ship, and a price of electricity purchased by the port from the ship.

Preferably, the strategy set Sₛ of a mobile microgrid of the ship represents a charging strategy and a discharging strategy of the ship.

Preferably, the energy supply equipment of the port includes a port diesel generator, a port energy storage system, and a renewable energy source power generation system;

the port diesel generator includes:

$${C}_{t}^{D G} = {\sum }_{n ∈ N} {c}_{n , t}^{DG} {P}_{n , t}^{DG} , ∀ t ∈ T \qquad ( 3 )$$

$$\{ \begin{matrix}{P}_{n , t}^{DG} - {R}_{n , t}^{DG} \geq {γ}_{n , t} \cdot {P}_{n , min}^{DG} \\ {P}_{n , t}^{DG} + {R}_{n , t}^{DG} \leq {γ}_{n , t} \cdot {P}_{n , max}^{DG}\end{matrix} , ∀ n ∈ N , ∀ t ∈ T \qquad ( 4 )$$

$$\{ \begin{matrix}{P}_{n , t - 1}^{DG} - {P}_{n , t}^{DG} \leq {γ}_{n , t - 1} \cdot {RD}_{n} + {z}_{n , t} \cdot {SD}_{n} \\ {P}_{n , t}^{DG} - {P}_{n , t - 1}^{DG} \leq {γ}_{n , t - 1} \cdot {RU}_{n} + {y}_{n , t} \cdot {SU}_{n}\end{matrix} , ∀ n ∈ N , ∀ t ∈ T$$

wherein RUₙ and RDₙ are respectively upper limits of a power increase range and a power decrease range of an n^{th} diesel generator; SDₙ and SUₙ are respectively starting and stopping power change values of the n^{th} diesel generator; γ_{n,t} is a start-stop state indicating variable of the n^{th} diesel generator at a time period t; P_{n,min}^{DG} and P_{n,max}^{DG} are upper and lower limits of an active output of the n^{th} diesel generator; N is a port diesel generator set; T is an overall current scheduling operation time period; Cₜ^{DG} is a cost of the port diesel generator at the time period t; [symbol] _{n,t}^{DG} is an output cost coefficient of the port diesel generator; P_{n,t}^{DG} is an active output of the n^{th} diesel generator of the port at the time period t; R_{n,t}^{DG} represents a spinning reserve of a generator set; z_{n,t} represents a generator set start indicating variable; and y_{n,t} represents a generator set stop indicating variable;

the port energy storage system includes:

$${P}^{pess , min} \leq {P}_{t}^{pess} \leq {P}^{pess , max} , ∀ t ∈ T \qquad ( 5 )$$

$$\{ \begin{matrix}{E}_{t}^{p e s s} = {E}_{t ‐ 1}^{p e s s} - \frac{{P}_{t}^{pess}}{{η}^{pdis}} Δ t , {P}_{t}^{pess} < 0 \\ {E}_{t}^{p e s s} = {E}_{t - 1}^{p e s s} + {P}_{t}^{pess} {η}^{pch} Δ t , {P}_{t}^{pess} \geq 0\end{matrix} , ∀ t ∈ T \qquad ( 6 )$$

$$\{ \begin{matrix}0 \leq {E}_{t}^{p e s s} \leq {E}_{t}^{pess , max} \\ {E}_{i n i}^{p e s s} = {E}_{T}^{p e s s}\end{matrix} , ∀ t ∈ T \qquad ( 7 )$$

where Eₜ^{pess,max} is an upper limit of a state of charge for energy storage; η^{pch} and η^{pdis} are respectively charging and discharging efficiencies of port energy storage equipment; Eₜ^{pess} represents a state of charge for energy storage of the port at the time period t; P^{pess,max} and P^{pess,min} are upper and lower limits of charging and discharging power for energy storage of the port; Eᵢₙᵢ^{pess} is an initial capacity for energy is a total scheduling time period; and T storage of the port; and T

the renewable energy source power generation system includes a photovoltaic power generation system and a wind power generation system, and outputs Pₜ^{PV} and Pₜ^{WT} of the photovoltaic power generation system and the wind power generation system can be predicted and obtained in a short term by using historical data based on machine learning, where Pₜ^{PV} and Pₜ^{WT} respectively represent photovoltaic and wind power active outputs at the time period t.

Preferably, step S2 uses:
S2.1: establishing an optimized objective function of the port:

$$( 8 )$$

$$max \{ {\sum }_{t ∈ T} [ {\sum }_{i ∈ I} ( {c}_{p e , t}^{s} {P}_{i , t}^{ch} Δ t - {c}_{p e , t}^{b} {P}_{i , t}^{dis} Δ t ) - {c}_{t}^{gb} {P}_{t}^{gb} Δ t + {c}_{t}^{gs} {P}_{t}^{gs} Δ t - {C}_{t}^{D G} ] + {\sum }_{t ∈ {T}_{b}} {\sum }_{i ∈ I} {c}_{i , t}^{ser} Δ t \}$$

where [symbol] ₜ^{gb} and [symbol] ₜ^{gs} are respectively a price of electricity purchased by the port from a power grid and a price of electricity sold by the port at the time period t; Pₜ^{gb} and Pₜ^{gs} are respectively a quantity of electricity purchased from the power grid and a quantity of electricity sold at the time period t; T is an overall current scheduling operation time period; T_{b} is a port berthing time period of the ship; Δt is an optimized scheduling time interval; [symbol] _{psi,t} is a berthing service charge of the i^{th} ship at the time period t; [symbol] _{pe,t}^{s} and [symbol] _{pe,t}^{b} are respectively a charge of the port selling electricity to the ship and a charge of the port purchasing electricity from the ship at the time period t; P_{i,t}^{ch} and P_{i,t}^{dis} are respectively charging and discharging power of the i^{th} ship at the time period t; [symbol] _{i,t}^{ser} represents a service charge of the i^{th}ship at the time period t; and I represents an in-port ship set participating in a port and ship interaction;
S2.2: establishing an optimized constraint condition of the port:

a port-ship energy transaction value constraint includes:

$${c}^{lo} \leq {c}_{p e , t}^{b} \leq {c}_{p e , t}^{s} \leq {c}^{up} \qquad ( 9 )$$

where [symbol] ^{up} and [symbol] ^{lo} are upper and lower limits of an energy transaction price between the port and the ship;

a power equilibrium constraint:

$${\sum }_{i ∈ I} ( {P}_{i , t}^{ch} - {P}_{i , t}^{dis} ) + {P}^{p e s s} + {P}^{pl} = {\sum }_{n ∈ N} {P}_{n ,}^{DG} + {P}_{t}^{PV} + {P}_{t}^{WT} \qquad ( 10 )$$

where Pₜ^{pl} is a self-load of the port at the time period t;
S2.3: establishing an optimized objective function of the ship:

$$min [ {\sum }_{t ∈ T} ( {c}_{p e , t}^{s} {P}_{t}^{ch} Δ t - {c}_{p e , t}^{b} {P}_{t}^{dis} Δ t ) + {\sum }_{t ∈ {T}_{b}} {c}_{ps , i , t} Δ t ] \qquad ( 11 )$$

where T is the overall current scheduling operation time period; T_{b} is the port berthing time period of the ship; Δt is the optimized scheduling time interval; [symbol] _{ps,i,t} is the berthing service charge of the i^{th} ship at the time period t; [symbol] _{pe,t}^{s} and [symbol] _{pe,t}^{b} are respectively the charge of the port selling electricity to the ship and the charge of the port purchasing electricity from the ship at the time period t; P_{i,t}^{ch} and P_{i,t}^{dis} are respectively the charging and discharging power of the i^{th} ship at the time period t; and
S2.4: establishing an optimized constraint condition of the ship:

an energy storage related constraint for an all-electric ship is as follows:

$$\{ \begin{matrix}0 \leq {P}_{i , t}^{sch} \leq {P}_{i , t}^{sch , max} \\ 0 \leq {P}_{i , t}^{sdis} \leq {P}_{i , t}^{sdis , max} \\ {P}_{i , t}^{sch} {P}_{i , t}^{sdis} = 0 \\ {E}_{i , t + 1}^{s} = {E}_{i , t}^{s} + {η}^{sch} {P}_{i , t}^{sch} Δ t − \frac{{P}_{i , t}^{sdis}}{{η}^{sdis}} Δ t\end{matrix} \text{} ∀ t ∈ {T}_{b} , ∀ i ∈ I \qquad ( 12 )$$

$$\begin{matrix}{P}_{i , t}^{sch} , {P}_{i , t}^{sdis} = 0 , & \text{} ∀ t ∉ {T}_{b} , ∀ i ∈ I\end{matrix} \qquad ( 13 )$$

where T_{b} is a port berthing time period of the ship; Δt is an optimized scheduling time interval; I is a set of ships planned to arrive at the port; P_{i,t}^{sch} and P_{i,t}^{sdis} are respectively charging and discharging power of shipborne energy storage of the i^{th} ship at the time period t; P_{i,t}^{sch,max} and P_{i,t}^{sdis,max} are respectively upper limit values of the charging and discharging power of shipborne energy storage of the i^{th} ship at the time period t; E_{i,t}^{s} is a charged energy of shipborne energy storage of the i^{th} ship at the time period t; η^{sch} and η^{sdis} are respectively the charging and discharging efficiencies; and P_{i,t}^{ch} and P_{i,t}^{dis} are respectively the charging and discharging power of the i^{th} ship at the time period t; and

a logistics related constraint is as follows:

assuming that loading and unloading rates of the in-port ships of the port in the scheduling time periods are substantially consistent,

$${\sum }_{t ∈ {T}_{b}} d {l}_{i} = {S}_{j} ∀ i ∈ N \qquad ( 14 )$$

where Sᵢ is a quantity of cargoes needed to be loaded and unloaded of the i^{th} ship, dlᵢ is a rate of the i^{th} ship loading and unloading the cargoes, and N is a set of the port diesel generators.

Preferably, step S3 uses:
S3.1: converting the port-and-ship layered game optimization model into a monolayer mixed integer linear model by using the Karush-Kuhn-Tucker optimality condition; and
S3.2: then solving the monolayer mixed integer linear model by using a commercial solver to finally obtain an optimal energy transaction price strategy of the port.

An integrated operation system for a port-and-ship energy and transportation system based on a layered game provided by the present invention includes:

a module M1, configured to formulate a layered game architecture for a port-and-ship integrated energy and transportation operation;

a module M2, configured to establish a port-and-ship layered game optimization model based on an optimized objective function and an optimized constraint condition of a port and an optimized objective function and an optimized constraint condition of a ship; and

a module M3, configured to, based on the port-and-ship layered game optimization model, solve, by the layered game architecture, an optimal integrated operation method for the port-and-ship energy and transportation system through a KKT optimality condition solving method;

where the port-and-ship layered game optimization model means that the port, as a superior guider, formulates and executes a strategy, the ship, as an inferior follower, makes corresponding responses by taking the strategy formulated by the port as a constraint, and the ship updates its strategy according to the responses made by the ship till reaching a game equilibrium.

Preferably, in the module M1:

$$G = \{ ( P ⋃ S ) ; {s}_{p} ; {F}_{p} ; {s}_{s} ; {F}_{s} \} \qquad ( 1 )$$

where P represents energy supply equipment of the port; S represents a ship set; Sₚ represents a strategy set of a fixed microgrid of the port; Sₛ represents a strategy set F of a mobile microgrid of the ship; Fₚ represents a net income realized by the strategy set of the fixed microgrid of the port; and Fₛ represents a net income realized by the strategy set of the mobile microgrid of the ship;

when the game reaches equilibrium, a utility function shall satisfy:

$${F}_{p} ( {s}_{p}^{*} , {s}_{s}^{*} ) \geq {F}_{p} ( {s}_{p} , {s}_{s}^{*} ) \qquad ( 2 )$$

$${F}_{s , i} ( {s}_{p}^{*} , {s}_{s , i}^{*} ) \geq {F}_{s , i} ( {s}_{p}^{*} , {s}_{s , ( - i )}^{*} , {s}_{s , i} )$$

where F_{s,i} is the utility function of an i^{th} ship; and S*_{s,(-i)} is a charging and discharging strategy set of other ships;

the strategy set Sₚ of the fixed microgrid of the port comprises active outputs of energy supply equipment, a price of electricity sold by the port to the ship, and a price of electricity purchased by the port from the ship;

the strategy set Sₛ of a mobile microgrid of the ship represents a charging strategy and a discharging strategy of the ship;

the energy supply equipment of the port comprises a port diesel generator, a port energy storage system, and a renewable energy source power generation system;

the port diesel generator includes:

$${C}_{t}^{D G} = {\sum }_{n ∈ N} {c}_{n , t}^{DG} {P}_{n , t}^{DG} , ∀ t ∈ T \qquad ( 3 )$$

$$\{ \begin{matrix}{P}_{n , t}^{DG} - {R}_{n , t}^{DG} \geq {γ}_{n , t} \cdot {P}_{n , min}^{DG} \\ {P}_{n , t}^{DG} + {R}_{n , t}^{DG} \leq {γ}_{n , t} \cdot {P}_{n , max}^{DG}\end{matrix} , ∀ n ∈ N , ∀ t ∈ T \qquad ( 4 )$$

$$\{ \begin{matrix}{P}_{n , t - 1}^{DG} - {P}_{n , t}^{DG} \leq {γ}_{n , t - 1} \cdot {RD}_{n} + {z}_{n , t} \cdot {SD}_{n} \\ {P}_{n , t}^{DG} - {P}_{n , t - 1}^{DG} \leq {γ}_{n , t - 1} \cdot {RU}_{n} + {y}_{n , t} \cdot {SU}_{n}\end{matrix} , ∀ n ∈ N , ∀ t ∈ T$$

where RUₙ and RDₙ are respectively upper limits of a power increase range and a power decrease range of an n^{th} diesel generator; SDₙ and SUₙ are respectively starting and stopping power change values of the n^{th} diesel generator; γ_{n,t} is a start-stop state indicating variable of the n^{th} diesel generator at a time period t; P_{n,min}^{Dg} and P_{n,max}^{DG} are upper and lower limits of an active output of the n^{th} diesel generator; N is a port diesel generator set; T is an overall current scheduling operation time period; Cₜ^{DG} is a cost of the port diesel generator at the time period t; [symbol] _{n,t}^{DG} is an output cost coefficient of the port diesel generator; P_{n,t}^{DG} is an active output of the n^{th} diesel generator of the port at the time period t; R_{n,t}^{DG} represents a spinning reserve of a generator set; z_{n,t} represents a generator set start indicating variable; and y_{n,t} represents a generator set stop indicating variable;

the port energy storage system includes:

$${P}^{pess , min} \leq {P}_{t}^{pess} \leq {P}^{pess , max} , ∀ t ∈ T \qquad ( 5 )$$

$$\{ \begin{matrix}{E}_{t}^{p e s s} = {E}_{t ‐ 1}^{p e s s} - \frac{{P}_{t}^{pess}}{{η}^{pdis}} Δ t , {P}_{t}^{pess} < 0 \\ {E}_{t}^{p e s s} = {E}_{t - 1}^{p e s s} + {P}_{t}^{pess} {η}^{pch} Δ t , {P}_{t}^{pess} \geq 0\end{matrix} , ∀ t ∈ T \qquad ( 6 )$$

$$\{ \begin{matrix}0 \leq {E}_{t}^{p e s s} \leq {E}_{t}^{pess , max} \\ {E}_{i n i}^{p e s s} = {E}_{T}^{p e s s}\end{matrix} , ∀ t ∈ T \qquad ( 7 )$$

where Eₜ^{pess,max} is an upper limit of a state of charge for energy storage; η^{pch} and η^{pdis} are respectively charging and discharging efficiencies of port energy storage pdis equipment; Eₜ^{pess} represents a state of charge for energy storage of the port at the time period t; P^{pess,max} and ^{pess,min} are upper and lower limits of charging and discharging power for energy storage of the port; Eᵢₙᵢ^{pess} is an initial capacity for energy storage of the port; and T is a total scheduling time period; and

the renewable energy source power generation system includes a photovoltaic power generation system and a wind power generation system, and outputs Pₜ^{PV} and Pₜ^{WT} of the photovoltaic power generation system and the wind power generation system can be predicted and obtained in a short term by using historical data based on machine learning, where Pₜ^{PV} and Pₜ^{PW} respectively represent photovoltaic and wind power active outputs at the time period t.

Preferably, in the module M2:

a module M2.1, configured to establish an optimized objective function of the port:

$$( 8 )$$

$$max \{ {\sum }_{t ∈ T} [ {\sum }_{i ∈ I} ( {c}_{p e , t}^{s} {P}_{i , t}^{ch} Δ t - {c}_{p e , t}^{b} {P}_{i , t}^{dis} Δ t ) - {c}_{t}^{gb} {P}_{t}^{gb} Δ t + {c}_{t}^{gs} {P}_{t}^{gs} Δ t - {C}_{t}^{D G} ] + {\sum }_{t ∈ {T}_{b}} {\sum }_{i ∈ I} {c}_{i , t}^{ser} Δ t \}$$

where [symbol] ₜ^{gb} and [symbol] ₜ^{gs} are respectively a price of electricity purchased by the port from a power grid and a price of electricity sold by the port at the time period t; Pₜ^{gb} and Pₜ^{gs} are respectively a quantity of electricity purchased from the power grid and a quantity of electricity sold at the time period t; T is an overall current scheduling operation time period; T_{b} is a port berthing time period of the ship; Δt is an optimized scheduling time interval; [symbol] _{ps,i,t} is a berthing service charge of the i^{th} ship at the time period t; [symbol] _{pe,t}^{s} and [symbol] _{pe,t}^{b} are respectively a charge of the port selling electricity to the pch i,t ship and a charge of the port purchasing electricity from the ship at the time period t; P_{i,t}^{ch} and P_{i,t}^{dis} are respectively charging and discharging power of the i^{th} ship at the time period t; [symbol] _{i,t}^{ser} represents a service charge of the i^{th} ship at the time period t; and I represents an in-port ship set participating in a port and ship interaction;

a module M2.2, configured to establish an optimized constraint condition of the port:

a port-ship energy transaction value constraint includes:

$$[ 11 ]$$

$${c}^{lo} \leq {c}_{p e , t}^{b} \leq {c}_{p e , t}^{s} \leq {c}^{up} \qquad [ 9 ]$$

where [symbol] ^{up} and [symbol] ^{lo} are upper and lower limits of an energy transaction price between the port and the ship;

a power equilibrium constraint:

$$[ 12 ]$$

$${\sum }_{i ∈ I} ( {P}_{i , t}^{ch} - {P}_{i , t}^{dis} ) + {P}^{pess} + {P}^{pl} = {\sum }_{n ∈ N} {P}_{n ,}^{DG} + {P}_{t}^{PV} + {P}_{t}^{WT} \qquad [ 10 ]$$

where Pₜ^{pl} is a self-load of the port at the time period t;

a module M2.3, configured to establish an optimized objective function of the ship:

$$min [ {\sum }_{t ∈ T} ( {c}_{pe , t}^{s} {P}_{i , t}^{ch} Δ t - {c}_{pe , t}^{b} {P}_{i , t}^{dis} Δ t ) + {\sum }_{t ∈ {T}_{b}} {c}_{p s , i , t} Δ t ] \qquad ( 11 )$$

where T is the overall current scheduling operation time period; T_{b} is the port berthing time period of the ship; Δt is the optimized scheduling time interval; [symbol] _{ps,i,t} is the berthing service charge of the i^{th} ship at the time period t; [symbol] _{pe,t}^{s} and [symbol] _{pe,t}^{b} are respectively the charge of the port selling electricity to the ship and the charge of the port purchasing electricity from the ship at the time period t; P_{i,it}^{ch} and P_{i,t}^{dis} are respectively the charging and discharging power of the i^{th} ship at the time period t; and

a module M2.4, configured to establish an optimized constraint condition of the ship:

an energy storage related constraint for an all-electric ship is as follows:

$$[ 14 ]$$

$$\{ \begin{matrix}0 \leq {P}_{i , t}^{sch} \leq {P}_{i , t}^{sch , max} \\ 0 \leq {P}_{i , t}^{sdis} \leq {P}_{i , t}^{sdis , max} \\ {P}_{i , t}^{sch} {P}_{i , t}^{sdis} = 0 \\ {E}_{i , t + 1}^{s} = {E}_{i , t}^{s} + {η}^{sch} {P}_{i , t}^{sch} Δ t − \frac{{P}_{i , t}^{sdis}}{{η}^{sdis}} Δ t\end{matrix} \text{} ∀ t ∈ {T}_{b} , ∀ i ∈ I \qquad [ 12 ]$$

$$[ 15 ]$$

$$\begin{matrix}{P}_{i , t}^{sch} , {P}_{i , t}^{sdis} = 0 , & \text{} ∀ t ∉ {T}_{b} , ∀ i ∈ I\end{matrix} \qquad [ 13 ]$$

where T_{b} is a port berthing time period of the ship; Δt is an optimized scheduling time interval; I is a set of ships planned to arrive at the port; P_{i,t}^{sch} and P_{i,t}^{sdis} are respectively charging and discharging power of shipborne energy storage of the i^{th} ship at the time period t; P_{i,t}^{sch,max} and P_{i,t}^{sdis,max} are respectively upper limit values of the charging and discharging power of shipborne energy storage of the i^{th} ship at the time period t; E_{i,t}^{s} is a charged energy of shipborne energy storage of the i^{th} ship at the time period t; η^{sch} and η^{sdis} are respectively the charging and discharging efficiencies; and P_{i,t}^{ch} and P_{i,t}^{dis} are respectively the charging and discharging power of the i^{th} ship at the time period t; and

a logistics related constraint is as follows:

assuming that loading and unloading rates of the in-port ships of the port in the scheduling time periods are substantially consistent,

$$[ 16 ]$$

$${\sum }_{t ∈ {T}_{b}} {dl}_{i} = {S}_{i} , ∀ i ∈ N \qquad [ 14 ]$$

where Sᵢ is a quantity of cargoes needed to be loaded and unloaded of the i^{th} ship, dlᵢ is a rate of the i^{th} ship loading and unloading the cargoes, and N is a set of the port diesel generators;

the module M3 includes:

a module M3.1, configured to convert the port-and-ship layered game optimization model into a monolayer mixed integer linear model by using the Karush-Kuhn-Tucker optimality condition; and

a module M3.2, configured to, then solve the monolayer mixed integer linear model by using a commercial solver to finally obtain an optimal energy transaction price strategy of the port.

### BRIEF DESCRIPTION OF THE DRAWINGS

By reading and referring to detailed description made by the following drawings to non-restrictive embodiments, other features, purposes and advantages of the present invention will become more obvious:

FIG. 1 is a flowchart of an integrated operation method for a port-and-ship energy and transportation system based on a layered game.

FIG. 2 shows a quantity of electricity purchased by the port from a power grid.

FIG. 3 shows an optimal pricing strategy for port-ship energy transaction.

### DETAILED DESCRIPTION OF THE EMBODIMENTS

The present invention will be described in detail below in combination with specific embodiments. The embodiments below contribute to further understanding the present invention by those skilled in the art but do not limit the present invention in any form. It should be noted that variations and improvements still can be made by those skilled in the technical field without departing the concept of the present invention. These fall into the scope of protection of the present invention.

The present invention aims to solve the overall operating economy of the port and ship energy and transportation system. Therefore, an object of the present invention is to provide an integrated operation method for a port-and-ship energy and transportation system based on a layered game to improve the overall operating economy of the micro energy system of the port and the mobile micro energy system of the ship, so as to guide the ships to berth orderly to accept the berth service and the energy transaction. The present invention has the following advantages.

A current marine energy transaction and service mechanism is established, the port serves as a leader and a constitutor of energy transaction and service prices, and the ships, serving as the followers, decide whether they participate in energy transaction between the port and the ships according to the energy transaction and service prices constituted by the port.

The layered game model for integrated port-and-ship energy and transportation operation is provided. By considering the response of the energy transaction and berth service strategies on the energy price and the berth service price after the ships reach the port, the income of the port can be increased, and the ship operating cost is lowered, the overall operating economy is improved, and a win-win between the port main body and the ship main body is achieved.

A ship to port (S2P) transaction behavior of the ship mobile microgrid to the port fixed microgrid is considered, so that the initiative of the ships participating port-ship energy transaction can be aroused efficiently.

The layered game model is converted into a mixed integer linear programming problem by using a Karush-Kuhn-Tucker optimality condition, so that the optimal pricing decision of port energy transaction is obtained by solving the problem.

The present invention provides the layered game model for integrated port-and-ship energy and transportation operation. The port plays a role of the leader and the constitutor for the energy transaction and service prices, and the ships play a role of followers for the energy and service transactions. By considering the response of the energy transaction and berth service strategies on the energy price and the berth service price after the ships reach the port, the overall port-and-ship operating economy is improved and a win-win between the port main body and the ship main body is achieved.

### Embodiment 1

The integrated operation method for a port-and-ship energy and transportation system based on a layered game provided by the present invention includes:
Step S1: a layered game architecture for a port-and-ship integrated energy and transportation operation is formulated;

In the layered game model, the port plays a role of a superior leader and sets the energy transaction price between the port and the ships preferentially, and the ships play a role of inferior followers and passively receive the energy transaction price information issued by the superior leader. The charging and discharging strategy of the ship will affect the final income of the superior leader in return.
Step S1 is specifically as follows: to make self-benefits of all game participants maximum, when setting the energy transaction price, the port cannot only consider its own benefit, but also consider the dynamic response behaviors of the ships, that is, there is a benefit game between the port and the ships. The layered principal and subordinate game between the port and the ships can be described as:

$$G = \{ ( P ⋃ S ) ; {s}_{p} ; {F}_{p} ; {s}_{s} ; {F}_{s} \} \qquad ( 1 )$$

where P represents the energy supply equipment of the port, including a port diesel generator, a port energy storage system, and a renewable energy source power generation system; S represents the ship set; Sₚ represents the strategy set of the fixed microgrid of the port, including active outputs of the energy supply equipment, a price of electricity sold by the port to the ship, and a price of electricity purchased by the port from the ship; Sₛ represents a mobile microgrid strategy of the ship, including a charging strategy and a discharging strategy of the ship; Fₚ represents a net income realized by F the strategy set of the fixed microgrid of the port; Fₛ represents a net income realized by the strategy set of the mobile microgrid of the ship;

the port diesel generator includes:

$$[ 17 ]$$

$${C}_{t}^{D G} = {\sum }_{n ∈ N} {c}_{n , t}^{DG} {P}_{n , t}^{DG} , ∀ t ∈ T \qquad ( 2 )$$

$$[ 18 ]$$

$$\{ \begin{matrix}{P}_{n , t}^{DG} - {R}_{n , t}^{DG} \geq {γ}_{n , t} \cdot {P}_{n , min}^{DG} \\ {P}_{n , t}^{DG} + {R}_{n , t}^{DG} \leq {γ}_{n , t} \cdot {P}_{n , max}^{DG}\end{matrix} , ∀ n ∈ N , ∀ t ∈ T \qquad ( 3 )$$

$$\{ \begin{matrix}{P}_{n , t - 1}^{DG} - {P}_{n , t}^{DG} \leq {γ}_{n , t - 1} \cdot {RD}_{n} + {z}_{n , t} \cdot {SD}_{n} \\ {P}_{n , t}^{DG} - {P}_{n , t - 1}^{DG} \leq {γ}_{n , t - 1} \cdot {RU}_{n} + {y}_{n , t} \cdot {SU}_{n}\end{matrix} , ∀ n ∈ N , ∀ t ∈ T$$

where RUₙ and RDₙ are respectively upper limits of a power increase range and a power decrease range of an n^{th} diesel generator; SDₙ and SUₙ are respectively starting and stopping power change values of the n^{th} diesel generator; γ_{n,t} is a start-stop state indicating variable of the n^{th} diesel generator at a time period t; P_{n,min}^{DG} and P_{n,max}^{DG} are upper and lower limits of an active output of the n^{th} diesel generator; N is a port diesel generator set; T is an overall current scheduling operation time period; Cₜ^{DG} is a cost of the port diesel generator at the time period t; [symbol] _{n,t}^{DG} is an output cost coefficient of the port diesel generator; P_{n,t}^{DG} is an active output of the n^{th} diesel generator of the port at the time period t; R_{n,t}^{DG} represents a spinning reserve of a generator set; z_{n,t} represents a start indicating variable of the generator set; and y_{n,t} represents a stop indicating variable of the generator set;

the port energy storage system includes:

$${P}^{pess , min} \leq {P}_{t}^{pess} \leq {P}^{pess , max} , ∀ t ∈ T \qquad ( 4 )$$

$$\{ \begin{matrix}{E}_{t}^{p e s s} = {E}_{t ‐ 1}^{p e s s} - \frac{{P}_{t}^{pess}}{{η}^{pdis}} Δ t , {P}_{t}^{pess} < 0 \\ {E}_{t}^{p e s s} = {E}_{t - 1}^{p e s s} + {P}_{t}^{pess} {η}^{pch} Δ t , {P}_{t}^{pess} \geq 0\end{matrix} , ∀ t ∈ T \qquad ( 5 )$$

$$\{ \begin{matrix}0 \leq {E}_{t}^{p e s s} \leq {E}_{t}^{pess , max} \\ {E}_{i n i}^{p e s s} = {E}_{T}^{p e s s}\end{matrix} , ∀ t ∈ T \qquad ( 6 )$$

where Eₜ^{pess,max} is an upper limit of a state of charge for energy storage; η^{pch} and η^{pdis} are respectively charging and discharging efficiencies of energy storage and equipment of the port; Eₜ^{pess} represents a state of charge for energy storage of the port at the time period t; P^{pess,max} and P^{pess,min} are upper and lower limits of charging and discharging power for energy storage of the port; Eᵢₙᵢ^{pess} is an initial capacity for energy storage of the port; and T is a total scheduling time period; and

the renewable energy source power generation system includes a photovoltaic power generation system and a wind power generation system, and outputs Pₜ^{PV} and Pₜ^{WT} of the photovoltaic power generation system and the wind power generation system can be predicted and obtained in a short term by using historical data based on machine learning, where Pₜ^{PV} and Pₜ^{WT} respectively represent photovoltaic and wind power active outputs at the time period t.

By set the energy transaction price between the port and the ships, the port optimizes its own operating strategy to maximize the net income Fₚ; and the ship reasonably arranges its own energy purchasing and selling strategy to maximize the own income Fₛ according to the energy transaction price set by the port because the mobile microgrid of the ship participates in port-ship integrated operation energy management by means of dynamic responses.

When the game reaches an equilibrium, any one of the port and ships cannot change their strategies unilaterally to obtain a higher income. The utility function shall satisfy:

$${F}_{p} ( {s}_{p}^{*} , {s}_{s}^{*} ) \geq {F}_{p} ( {s}_{p} , {s}_{s}^{*} ) \qquad ( 7 )$$

$${F}_{s , i} ( {s}_{p}^{*} , {s}_{s , j}^{*} ) \geq {F}_{s , i} ( {s}_{p}^{*} , {s}_{s , ( - i )}^{*} , {s}_{s , i} )$$

where F_{s,i} is the utility function of an i^{th} ship; and S*_{s,(-i)} is a charging and discharging strategy set of other ships.
Step S2: a port-and-ship layered game optimization model is established based on an optimized objective function and an optimized constraint condition of a port and an optimized objective function and an optimized constraint condition of a ship;

the step S2 specifically includes:
Step S2.1: the port, as the leader of the marine energy transaction and service prices, takes the maximum net income as the optimized operation target, and its net income includes an income obtained by selling energy to the berthed ships, an income obtained by providing the berth service to the berthed ships, a cost of purchasing electricity from a superior public power grid, and a fuel cost of its own energy supply equipment. An optimized objective function of the port is established:

$$( 8 )$$

$$max \{ {\sum }_{t ∈ T} [ {\sum }_{i ∈ I} ( {c}_{p e , t}^{s} {P}_{i , t}^{ch} Δ t - {c}_{p e , t}^{b} {P}_{i , t}^{dis} Δ t ) - {c}_{t}^{gb} {P}_{t}^{gb} Δ t + {c}_{t}^{gs} {P}_{t}^{gs} Δ t - {C}_{t}^{D G} ] + {\sum }_{t ∈ {T}_{b}} {\sum }_{i ∈ I} {c}_{i , t}^{ser} Δ t \}$$

where [symbol] ₜ^{gb} and [symbol] ₜ^{gs} are respectively a price of electricity purchased by the port from a power grid and a price of electricity sold by the port at the time period t; Pₜ^{gb} and Pₜ^{gs} are respectively a quantity of electricity purchased from the power grid and a quantity of electricity sold at the time period t; T is an overall current scheduling operation time period; T_{b} is a port berthing time period of the ship; Δt is an optimized scheduling time interval; [symbol] _{ps,i,t} is a berthing service charge of the i^{th} ship at the time period t; [symbol] _{pe,t}^{s} and [symbol] _{pe,t}^{b} are respectively a charge of the port selling electricity to the ship and a charge of the port purchasing electricity from the ship at the time period t; P_{i,t}^{ch} and P_{i,t}^{dis} are respectively charging and discharging power of the i^{th} ship at the time period t; [symbol] _{i,t}^{ser} represents a service charge of the i^{th} ship at the time period t; and I represents an in-port ship set participating in a port and ship interaction;
Step S2.2: an optimized constraint condition of the port is established:

a port-ship energy transaction value constraint includes:

$${c}^{lo} \leq {c}_{p e , t}^{b} \leq {c}_{p e , t}^{s} \leq {c}^{up} \qquad ( 9 )$$

up [symbol] ^{up} and [symbol] ^{lo} are upper and lower limits of an energy transaction price between the port and the ship;

a power equilibrium constraint:

$${\sum }_{i ∈ I} ( {P}_{i , t}^{ch} - {P}_{i , t}^{dis} ) + {P}^{p e s s} + {P}^{pl} = {\sum }_{n ∈ N} {P}_{n ,}^{DG} + {P}_{t}^{PV} + {P}_{t}^{WT} \qquad ( 10 )$$

where Pₜ^{pl} is a self-load of the port at the time period t;
Step S2.3: the port sets the price of providing energy transaction and berth service to the ships, and the ships decide a strategy of consuming energy and receiving the berth service according to the set price to maximize its own income, and its target function can be represented as:

$$min [ {\sum }_{t ∈ T} ( {c}_{p e , t}^{s} {P}_{t}^{ch} Δ t - {c}_{p e , t}^{b} {P}_{t}^{dis} Δ t ) + {\sum }_{t ∈ {T}_{b}} {c}_{ps , i , t} Δ t ] \qquad ( 11 )$$

where T is the overall current scheduling operation time period; T_{b} is the port berthing time period of the ship; Δtis the optimized scheduling time interval; [symbol] _{ps,i,t} is the berthing service charge of the i^{th} ship at the time period t; [symbol] _{pe,t}^{s} and [symbol] _{pe,t}^{b} are respectively the charge of the port selling electricity to the ship and the charge of the port purchasing electricity from the ship at the time period t; P_{i,t}^{ch} and P_{i,t}^{dis} are respectively the charging and discharging power of the i^{th} ship at the time period t; and
Step S2.4: an optimized constraint condition of the ship is established;

an energy storage related constraint for an all-electric ship is as follows:

$$\{ \begin{matrix}0 \leq {P}_{i , t}^{sch} \leq {P}_{i , t}^{sch , max} \\ 0 \leq {P}_{i , t}^{sdis} \leq {P}_{i , t}^{sdis , max} \\ {P}_{i , t}^{sch} {P}_{i , t}^{sdis} = 0 \\ {E}_{i , t + 1}^{s} = {E}_{i , t}^{s} + {η}^{sch} {P}_{i , t}^{sch} Δ t − \frac{{P}_{i , t}^{sdis}}{{η}^{sdis}} Δ t\end{matrix} \text{} ∀ t ∈ {T}_{b} , ∀ i ∈ I \qquad ( 12 )$$

$$\begin{matrix}{P}_{i , t}^{sch} , {P}_{i , t}^{sdis} = 0 , & \text{} ∀ t ∉ {T}_{b} , ∀ i ∈ I\end{matrix} \qquad ( 13 )$$

where T_{b} is a port berthing time period of the ship; Δt is an optimized scheduling time interval; I is a set of ships planned to arrive at the port; P_{i,t}^{sch} and P_{i,t}^{sdis} are respectively charging and discharging power of shipborne energy storage of the i^{th} ship at the time period t; P_{i,t}^{sch,max} and P_{i,t}^{dis,max} are respectively upper limit values of the charging and discharging power of shipborne energy storage of the i^{th} ship at the time period t; E_{i,t}^{s} is a charged energy of shipborne energy storage of the i^{th} ship at the time period t; η^{sch} and η^{sdis} are respectively the charging and discharging efficiencies of shipborne energy storage; and P_{i,t}^{ch} and P_{i,t}^{dis} are respectively the charging and discharging power of the i^{th} ship at the time period t; and

a logistics related constraint is as follows:

assuming that loading and unloading rates of the in-port ships of the port in the scheduling time periods are substantially consistent,

$${\sum }_{t ∈ {T}_{b}} {dl}_{i} = {S}_{i} , ∀ i ∈ N \qquad ( 14 )$$

where Sᵢ is a quantity of cargoes needed to be loaded and unloaded of the i^{th} ship, dlᵢ is a cargo loading and unloading rate of the i^{th} ship, and N is a set of the port diesel generators.
Step S3: based on the port-and-ship layered game optimization model, solving by the layered game architecture to obtain an optimal integrated operation method for the port-and-ship energy and transportation system through a KKT (Karush-Kuhn-Tucker) optimality condition solving method;
Step S3 is specifically as follows: the port-ship layered game model belongs to a double-layered programming problem, where a charging and discharging complementary constraint P_{i,t}^{sch}P_{i,t}^{sdis}=0 of the inferior model can loosen a constraint, so as to convert the inferior model from a non-convex model into a linear programming model; the double-layered programming problem is converted into the monolayer mixed integer linear programming problem through the Karush-Kuhn-Tucker optimality condition, and then the problem is then solved by the commercial solver with high efficiency to finally obtain the optimal energy transaction price strategy of the port.
Step S3.1: converting the port-and-ship layered game optimization model into a monolayer mixed integer linear model by using the Karush-Kuhn-Tucker optimality condition; and
Step S3.2: then solving the monolayer mixed integer linear model by using a commercial solver to finally obtain an optimal energy transaction price strategy of the port.

The layered game architecture: layered principal and subordinate games can be regarded as a type of special non-zero and non-cooperative games. A participant 1 plays a leading role who formulates and executes an individual strategy. A participant 2 constrained by the strategy of the participant 1 makes a rational response. The participant 1, in view of the rational response of the participant 2, then rationally selects its own strategy. Finally, the two reaches an equilibrium, and any one of the two cannot change their strategies to obtain a higher income.

The port-and-ship layered game optimization model is the layered game between the port and the ships: the port plays a role of the superior leader and the constitutor for the energy transaction and service prices and the ships play a role of inferior followers for the energy and service transactions. The port, as a superior guider, formulates and executes a strategy, the ship, as an inferior follower, makes corresponding responses by taking the strategy formulated by the port as a constraint, and the port updates its strategy according to the responses made by the ship till reaching a game equilibrium.

An integrated operation system for a port-and-ship energy and transportation system based on a layered game provided by the present invention includes:

a module M1, configured to formulate a layered game architecture for a port-and-ship integrated energy and transportation operation;

In the layered game model, the port plays a role of a superior leader and sets the energy transaction price between the port and the ships preferentially, and the ships play a role of inferior followers and passively receive the energy transaction price information issued by the superior leader. The charging and discharging strategy of the ship will affect the final income of the superior leader in return.

The module M1 is specifically as follows: to make self-benefits of all game participants maximum, when setting the energy transaction price, the port cannot only consider its own benefit, but also consider the dynamic response behaviors of the ships, that is, there is a benefit game between the port and the ships. The layered principal and subordinate game between the port and the ships can be described as:

$$G = \{ ( P ⋃ S ) ; {s}_{p} ; {F}_{p} ; {s}_{s} ; {F}_{s} \} \qquad ( 1 )$$

where P represents the energy supply equipment of the port, including a port diesel generator, a port energy storage system, and a renewable energy source power generation system; S represents the ship set; Sₚ represents the strategy set of the fixed microgrid of the port, including active outputs of the energy supply equipment, a price of electricity sold by the port to the ship, and a price of electricity purchased by the port from the ship; Sₛ represents a mobile microgrid strategy of the ship, including a charging strategy and a discharging strategy of the ship; Fₚ represents a net income realized by the strategy set of the fixed microgrid of the port; Fₛ represents a net income realized by the strategy set of the mobile microgrid of the ship;

the port diesel generator includes:

$${C}_{t}^{DG} = {\sum }_{n ∈ N} {c}_{n , t}^{DG} {P}_{n , t}^{DG} , \qquad ( 2 )$$

$$∀ t ∈ T$$

$$\{ \begin{matrix}{P}_{n , t}^{DG} - {R}_{n , t}^{DG} \geq {γ}_{n , t} \cdot {P}_{n , min}^{DG} \\ {P}_{n , t}^{DG} + {R}_{n , t}^{DG} \leq {γ}_{n , t} \cdot {P}_{n , max}^{DG}\end{matrix} ,$$

$$∀ n ∈ N ,$$

$$∀ t ∈ T$$

$$\{ \begin{matrix}{P}_{n , t - 1}^{DG} - {P}_{n , t}^{DG} \leq {γ}_{n , t - 1} \cdot {RD}_{n} + {z}_{n , t} \cdot {SD}_{n} \\ {P}_{n , t}^{DG} - {P}_{n , t - 1}^{DG} \leq {γ}_{n , t - 1} \cdot {RU}_{n} + {y}_{n , t} \cdot {SU}_{n}\end{matrix} , \qquad ( 3 )$$

$$∀ n ∈ N ,$$

$$∀ t ∈ T$$

where RUₙ and RDₙ are respectively upper limits of a power increase range and a power decrease range of an n^{th} diesel generator; SDₙ and SUₙ are respectively starting and stopping power change values of the n^{th} diesel generator; γ_{n,t} is a start-stop state indicating variable of the n^{th} diesel generator at a time period t; P_{n,min}^{DG} and P_{n,max}^{DG} are upper and lower limits of an active output of the n^{th} diesel generator; N is a port diesel generator set; T is an overall current scheduling operation time period; Cₜ^{DG} is a cost of the port diesel generator at the time period t; [symbol] _{n,t}^{DG} is an output cost coefficient of the port diesel generator; P_{n,t}^{DG} is an active output of the n^{th} diesel generator of the port at the time period t; R_{n,t}^{DG} represents a spinning reserve of a generator set; z_{n,t} represents a start indicating variable of the generator set; and y_{n,t} represents a stop indicating variable of the generator set;

the port energy storage system includes:

$${P}^{pess , min} \leq {P}_{t}^{pess} \leq {P}^{pess , max} , \qquad ( 4 )$$

$$∀ t ∈ T$$

$$\{ \begin{matrix}{E}_{t}^{pess} = {E}_{t - 1}^{pess} - \frac{{P}_{t}^{pess}}{{η}^{pdis}} Δ t , & {P}_{t}^{pess} < 0 \\ {E}_{t}^{pess} = {E}_{t - 1}^{pess} + {P}_{t}^{pess} {η}^{pch} Δ t , & {P}_{t}^{pess} \geq 0\end{matrix} , \qquad ( 5 )$$

$$∀ t ∈ T$$

$$\{ \begin{matrix}0 \leq {E}_{t}^{pess} \leq {E}_{t}^{pess , max} \\ {E}_{ini}^{pess} = {E}_{T}^{pess}\end{matrix} , \qquad ( 6 )$$

$$∀ t ∈ T$$

where Eₜ^{pess,max} is an upper limit of a state of charge for energy storage; η^{pch} and η^{pdis} are respectively charging and discharging efficiencies of energy storage equipment of the port; Eₜ^{pess} represents a state of charge for energy storage of the port at the time period t; P^{pess,max} and P^{pess,min} are upper and lower limits of charging and discharging power for energy storage of the port; Eᵢₙᵢ^{pess} is an initial capacity for energy storage of the port; and T is a total scheduling time period; and

the renewable energy source power generation system includes a photovoltaic power generation system and a wind power generation system, and outputs Pₜ^{PV} and Pₜ^{WT} of the photovoltaic power generation system and the wind power generation system can be predicted and obtained in a short term by using historical data based on machine learning, where Pₜ^{PV} and Pₜ^{WT} respectively represent photovoltaic and wind power active outputs at the time period t.

By setting the energy transaction price between the port and the ships, the port optimizes its own operating strategy to maximize the net income Fₚ; and the ship reasonably arranges its own energy purchasing and selling strategy to maximize the own income Fₛ according to the energy transaction price set by the port because the mobile microgrid of the ship participates in port-ship integrated operation energy management by means of dynamic responses.

When the game reaches an equilibrium, any one of the port and ships cannot change their strategies unilaterally to obtain a higher income. The utility function shall satisfy:

$${F}_{p} ( {s}_{p}^{*} , {s}_{s}^{*} ) \geq {F}_{p} ( {s}_{p} , {s}_{s}^{*} ) \qquad ( 7 )$$

$${F}_{s , i} ( {s}_{p}^{*} , {s}_{s , i}^{*} ) \geq {F}_{s , i} ( {s}_{p}^{*} , {s}_{s , ( - i )}^{*} , {s}_{s , i} )$$

where F_{s,i} is the utility function of an i^{th} ship; and S*_{s,(-i)} is a charging and discharging strategy set of other ships.

a module M2, configured to establish a port-and-ship layered game optimization model based on an optimized objective function and an optimized constraint condition of a ort and an optimized objective function and an optimized constraint condition of a ship; and

the module M2 specifically includes:

a module 2.1: the port, as the leader of the marine energy transaction and service prices, takes the maximum net income as the optimized operation target, and its net income includes an income obtained by selling energy to the berthed ships, an income obtained by providing the berth service to the berthed ships, a cost of purchasing electricity from a superior public power grid, and a fuel cost of its own energy supply equipment. An optimized objective function of the port is established:

$$max \{ {\sum }_{t ∈ T} [ {\sum }_{i ∈ I} ( {c}_{p e , t}^{s} {P}_{i , t}^{c h} Δ t - {c}_{p e , t}^{b} {P}_{i , t}^{dis} Δ t ) - {c}_{t}^{gb} {P}_{t}^{gb} Δ t + {c}_{t}^{gs} {P}_{t}^{gs} Δ t - {C}_{t}^{DG} ] + {\sum }_{t ∈ {T}_{b}} {\sum }_{i ∈ I} {c}_{i , t}^{ser} Δ t \} \qquad ( 8 )$$

where and [symbol] ₜ^{gb} and [symbol] ₜ^{gs} are respectively a price of electricity purchased by the port from a power grid and a price of electricity sold by the port at the time period t; Pₜ^{gb} and Pₜ^{gs} are respectively a quantity of electricity purchased from the power grid and a quantity of electricity sold at the time period t; T is an overall current scheduling operation time period; T_{b} is a port berthing time period of the ship; Δf is an optimized scheduling time interval; [symbol] _{ps,i,t} is a berthing service charge of the i^{th} ship at the time period t; [symbol] _{pe,t}^{s} and [symbol] _{pe,t}^{b} are respectively a charge of the port selling electricity to the ship and a charge of the port purchasing electricity from the ship at the time period t; P_{i,t}^{ch} and P_{i,t}^{dis} are respectively charging and discharging power of the i^{th} ship at the time period t; [symbol] _{i,t}^{ser} represents a service charge of the i^{th} ship at the time period t; and I represents an in-port ship set participating in a port and ship interaction;

a module M2.2, configured to establish an optimized constraint condition of the port:

a port-ship energy transaction value constraint includes:

$$[ 20 ] {c}^{lo} \leq {c}_{pe , t}^{b} \leq {c}_{pe , t}^{s} \leq {c}^{up} \qquad ( 9 )$$

where [symbol] ^{up} and [symbol] ^{lo} are upper and lower limits of an energy transaction price between the port and the ship;

a power equilibrium constraint:

$${\sum }_{i ∈ I} ( {P}_{i , t}^{ch} - {P}_{i , t}^{dis} ) + {P}^{pess} + {P}^{pl} = {\sum }_{n ∈ N} {P}_{n}^{DG} + {P}_{t}^{PV} + {P}_{t}^{WT} \qquad ( 10 )$$

where Pₜ^{pl} is a self-load of the port at the time period t;

a module M2.3: the port sets the price of providing energy transaction and berth service to the ships, and the ships decide a strategy of consuming energy and receiving the berth service according to the set price to maximize its own income, and its target function can be represented as:

$$min [ {\sum }_{t ∈ T} ( {c}_{pe , t}^{s} {P}_{i , t}^{ch} Δ t - {c}_{pe , t}^{b} {P}_{i , t}^{dis} Δ t ) + {\sum }_{t ∈ {T}_{b}} {c}_{ps , i , t} Δ t ] \qquad ( 11 )$$

where T is the overall current scheduling operation time period; T_{b} is the port berthing time period of the ship; Δt is the optimized scheduling time interval; [symbol] _{ps,i,t} is the berthing service charge of the i^{th} ship at the time period t; [symbol] _{pe,t}^{s} and [symbol] _{pe,t}^{b} are respectively the charge of the port selling electricity to the ship and the charge of the port purchasing electricity from the ship at the time period t; P_{i,t}^{ch} and P_{i,t}^{dis} are respectively the charging and discharging power of the i^{th} ship at the time period t; and

a module M2.4, configured to establish an optimized constraint condition of the ship:

an energy storage related constraint for an all-electric ship is as follows:

$$\{ \begin{matrix}0 \leq {P}_{i , t}^{sch} \leq {P}_{i , t}^{sch , max} \\ 0 \leq {P}_{i , t}^{sdis} \leq {P}_{i , t}^{sdis , max} \\ {P}_{i , t}^{sch} {P}_{i , t}^{sdis} = 0 \\ {E}_{i , t + 1}^{s} = {E}_{i , t}^{s} + {η}^{sch} {P}_{i , t}^{sch} Δ t - \frac{{P}_{i , t}^{sdis}}{{η}^{sdis}} Δ t\end{matrix} \qquad ( 12 )$$

$$∀ t ∈ {T}_{b} ,$$

$$∀ i ∈ I$$

$${P}_{i , t}^{sch} , {P}_{i , t}^{sdis} = 0 , \qquad ( 13 )$$

$$∀ t ∉ {T}_{b} ,$$

$$∀ i ∈ I$$

where T_{b} is a port berthing time period of the ship; Δt is an optimized scheduling time interval; I is a set of ships planned to arrive at the port; P_{i,t}^{sch} and P_{i,t}^{sdis} are respectively charging and discharging power of shipborne energy storage of the i^{th} ship at the time period t; P_{i,t}^{sch,max} and P_{i,t}^{sdis,max} are respectively upper limit values of the charging and discharging power of shipborne energy storage of the i^{th} ship at the time period t; E_{i,t}^{s} is a charged energy of shipborne energy storage of the i^{th} ship at the time period t; η^{sch} and η^{sdis} are respectively the charging and discharging efficiencies of and shipborne energy storage; and P_{i,t}^{ch} and P_{i,t}^{dis} are respectively the charging and discharging power of the i^{th} ship at the time period t; and

a logistics related constraint is as follows:

assuming that loading and unloading rates of the in-port ships of the port in the scheduling time periods are substantially consistent,

$${\sum }_{t ∈ {T}_{b}} {dl}_{i} = {S}_{i} , \qquad ( 14 )$$

$$∀ i ∈ N$$

where Sᵢ is a quantity of cargoes needed to be loaded and unloaded of the i^{th} ship, dlᵢ is a cargo loading and unloading rate of the i^{th} ship, and N is a set of the port diesel generators.

a module M3, configured to, based on the port-and-ship layered game optimization model, solve by the layered game architecture to obtain an optimal integrated operation method for the port-and-ship energy and transportation system through a KKT optimality condition solving method;

The module M3 is specifically as follows: the port-ship layered game model belongs to a double-layered programming problem, where a charging and discharging complementary constraint P_{i,t}^{sch}P_{i,t}^{sdis}=0 of the inferior model can loosen a constraint, so as to convert the inferior model from a non-convex model into a linear programming model; the double-layered programming problem is converted into the monolayer mixed integer linear programming problem through the Karush-Kuhn-Tucker optimality condition, and then the problem is then solved by the commercial solver with high efficiency to finally obtain the optimal energy transaction price strategy of the port;

a module M3.1, configured to convert the port-and-ship layered game optimization model into a monolayer mixed integer linear model by using the Karush-Kuhn-Tucker optimality condition; and

a module M3.2, configured to, then solve the monolayer mixed integer linear model by using a commercial solver to finally obtain an optimal energy transaction price strategy of the port.

The layered game architecture: layered principal and subordinate games can be regarded as a type of special non-zero and non-cooperative games. A participant 1 plays a leading role who formulates and executes an individual strategy. A participant 2 constrained by the strategy of the participant 1 makes a rational response. The participant 1, in view of the rational response of the participant 2, then rationally selects its own strategy. Finally, the two reaches an equilibrium, and any one of the two cannot change their strategies to obtain a higher income.

The port-and-ship layered game optimization model is the layered game between the port and the ships: the port plays a role of the superior leader and the constitutor for the energy transaction and service prices and the ships play a role of inferior followers for the energy and service transactions. The port, as a superior guider, formulates and executes a strategy, the ship, as an inferior follower, makes corresponding responses by taking the strategy formulated by the port as a constraint, and the port updates its strategy according to the responses made by the ship till reaching a game equilibrium.

### Embodiment 2

Embodiment 2 is a preferred embodiment of the embodiment 1.

Considering that 15 all electric ships with different cargo quantities loaded reach the port and participate in the energy transaction between the port and the ships, the energy storage capacity of the port is 24 MWh and the charging and discharging efficiencies both are 85%.

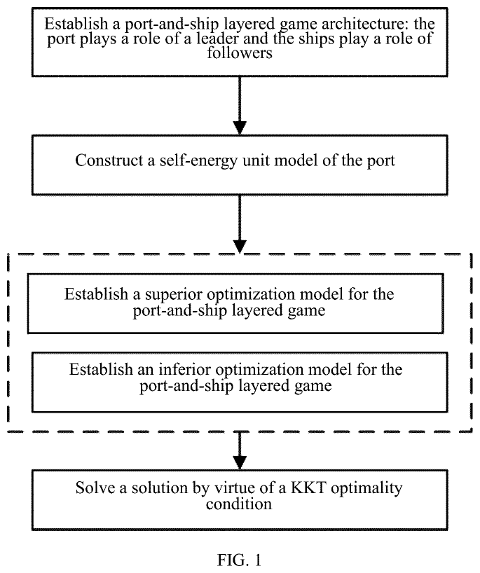

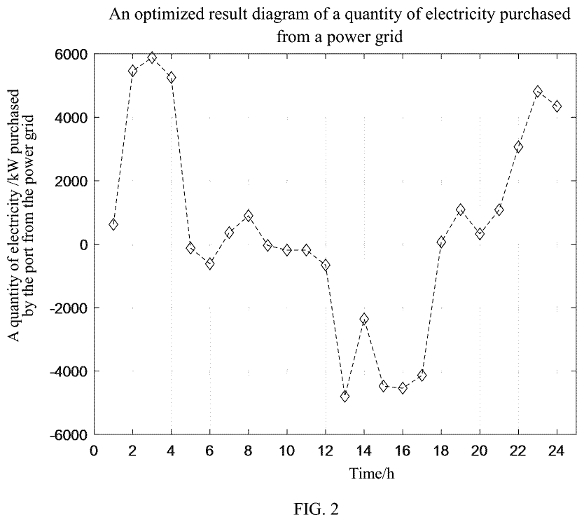

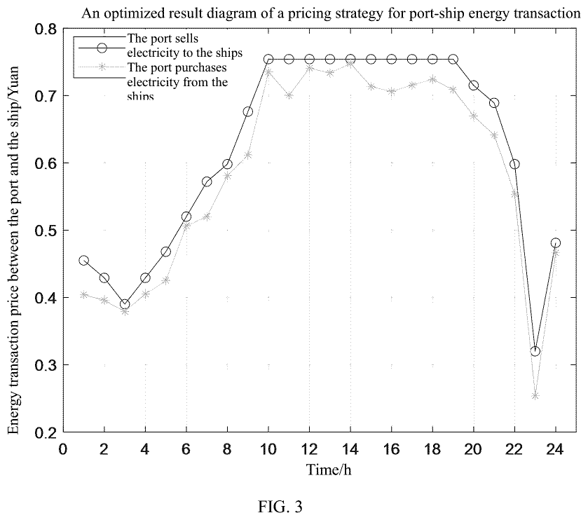

Referring to FIG. 1 to FIG. 3, it is shown by the example that based on the layered game model, the port-ship energy and transportation integrated system achieves the optimized decision of the energy transaction price between the port and the ships and the ordered guidance of the ships berthed to participate in the energy transaction, so that the overall operating economy is effectively improved.

Those skilled in the art shall know that except in form of a pure way of a computer readable program code to implement the system, device and modules thereof provided by the present invention, the system, device and modules thereof provided by the present invention can implement the same program in form of a logic gate, a switch, an application-specific integrated circuit, a programmable logic controller, an embedded microcontroller and the like by logically programming the method steps. Therefore, the system, device and modules thereof provided by the present invention are considered a hardware part so that the modules of various programs included therein are also considered structures in the hardware part. Modules for implementing various functions can be also considered software programs that implement the method and the structures in the hardware part.

Compared with the prior art, the present invention has the following beneficial effects:
1. A marine energy and service transaction mechanism is established to achieve energy transaction and service management of a ship mobile microgrid and a port micro energy grid at the same time.
2. The port-ship layered game model is established, and the port micro energy grid guides the ship berthing service and the energy transaction by setting the price, so that the overall operating economy can be effectively achieved.
3. A ship to port (S2P) transaction behavior of the ship mobile microgrid to the port fixed microgrid is considered, so that the initiative of the ships participating port-ship energy transaction can be aroused efficiently.
4. The layered principal and subordinate game model is converted into a mixed integer linear programming problem by using a Karush-Kuhn-Tucker condition, so that the optimal pricing decision of port energy is solved and obtained.
5. The layered game model for integrated port-and-ship energy and transportation operation is established to solve the energy transaction and service management problem of the ship mobile microgrid and the port micro energy grid. By considering the response of the energy transaction strategy between the port and the ships after the ships are berthed, the income of the port can be increased, and the ship berthing operating cost is lowered, the overall operating economy is improved, and a win-win between the port and the ship is achieved.

Specific embodiments of the present invention are described above. It is needed to understand that the present invention is not limited to the specific embodiments, and those skilled in the art can made various variations or modifications within the scope of the claims without affecting the substantial contents of the present invention. In the absence of conflict, the embodiments of the application and features in the embodiments can be combined with one another arbitrarily.

1. An integrated operation method for a port-and-ship energy and transportation system based on a layered game, comprising:
step S1: formulating a layered game architecture for a port-and-ship integrated energy and transportation operation;
step S2: establishing a port-and-ship layered game optimization model based on an optimized objective function and an optimized constraint condition of a port and an optimized objective function and an optimized constraint condition of a ship; and
step S3: based on the port-and-ship layered game optimization model, solving, by the layered game architecture, to obtain an optimal integrated operation method for the port-and-ship energy and transportation system through a KKT (Karush-Kuhn-Tucker) optimality condition solving method;
wherein the port-and-ship layered game optimization model is configured to use the port as a superior guider to formulate and execute a strategy, use the ship as an inferior follower to make corresponding responses by taking the strategy formulated by the port as a constraint, and allow the port to update the strategy according to the corresponding responses made by the ship till reaching a game equilibrium.

2. The integrated operation method for a port and ship energy and transportation system based on a layered game according to claim 1, wherein step S1 uses:
$$G = \{ ( P ⋃ S ) ; {s}_{p} ; {F}_{p} ; {s}_{s} ; {F}_{s} \} \qquad ( 1 )$$
where P represents energy supply equipment of the port; S represents a ship set; Sₚ represents a strategy set of a fixed microgrid of the port; Sₛ represents a strategy set of a mobile microgrid of the ship; Fₚ represents a net income realized by the strategy set of the fixed microgrid of the port; and Fₛ represents a net income realized by the strategy set of the mobile microgrid of the ship;
when the game equilibrium is reached, a utility function satisfies:
$${F}_{p} ( {s}_{p}^{*} , {s}_{s}^{*} ) \geq {F}_{p} ( {s}_{p} , {s}_{s}^{*} ) \qquad ( 2 )$$
$${F}_{s , i} ( {s}_{p}^{*} , {s}_{s , i}^{*} ) \geq {F}_{s , i} ( {s}_{p}^{*} , {s}_{s , ( - i )}^{*} , {s}_{s , i} )$$
where F_{s,i} is the utility function of an i^{th} ship; and S*_{s,(-i)} is a charging and discharging F strategy set of other ships.

3. The integrated operation method according to claim 2, wherein the strategy set Sₚ of the fixed microgrid of the port comprises active outputs of the energy supply equipment, a price of electricity sold by the port to the ship, and a price of electricity purchased by the port from the ship.

4. The integrated operation method according to claim 2, wherein the strategy set Sₛ of the mobile microgrid of the ship represents a charging strategy and a discharging strategy of the ship.

5. The integrated operation method according to claim 2, wherein the energy supply equipment of the port comprises a port diesel generator, a port energy storage system, and a renewable energy source power generation system;
the port diesel generator comprises:
$${C}_{t}^{DG} = {\sum }_{n ∈ N} {c}_{n , t}^{DG} {P}_{n , t}^{DG} , \qquad ( 3 )$$
$$∀ t ∈ T$$
$$\{ \begin{matrix}{P}_{n , t}^{DG} - {R}_{n , t}^{DG} \geq {γ}_{n , t} \cdot {P}_{n , min}^{DG} \\ {P}_{n , t}^{DG} + {R}_{n , t}^{DG} \leq {γ}_{n , t} \cdot {P}_{n , max}^{DG}\end{matrix} ,$$
$$∀ n ∈ N ,$$
$$∀ t ∈ T$$
$$\{ \begin{matrix}{P}_{n , t - 1}^{DG} - {P}_{n , t}^{DG} \leq {γ}_{n , t - 1} \cdot {RD}_{n} + {z}_{n , t} \cdot {SD}_{n} \\ {P}_{n , t}^{DG} - {P}_{n , t - 1}^{DG} \leq {γ}_{n , t - 1} \cdot {RU}_{n} + {y}_{n , t} \cdot {SU}_{n}\end{matrix} , \qquad ( 4 )$$
$$∀ n ∈ N ,$$
$$∀ t ∈ T$$
where RUₙ and RDₙ are respectively upper limits of a power increase range and a power decrease range of an n^{th} diesel generator; SDₙ and SUₙ are respectively power change values of the n^{th} diesel generator when starting and stopping; γ_{n,t} is a start-stop state indicating variable of the n^{th} diesel generator at a time period t; P_{n,min}^{DG} and P_{n,max}^{DG} are upper and lower limits of an active output of the n^{th} diesel generator; N is a port diesel generator set; T is an overall current scheduling operation time period; Cₜ^{DG} is a cost of the port diesel generator at the time period t; [symbol] _{n,t}^{DG} is an output cost coefficient of the port diesel generator; DG P_{n,t}^{DG} is an active output of the n^{th} diesel generator of the port at the time period t; R_{n,t}^{DG} represents a spinning reserve of a generator set; z_{n,t} represents a start indicating variable of the generator set; and y_{n,t} represents a stop indicating variable of the generator set;
the port energy storage system comprises:
$${P}^{pess , min} \leq {P}_{t}^{pess} \leq {P}^{pess , max} , \qquad ( 5 )$$
$$∀ t ∈ T$$
$$\{ \begin{matrix}{E}_{t}^{pess} = {E}_{t - 1}^{pess} - \frac{{P}_{t}^{pess}}{{η}^{pdis}} Δ t , & {P}_{t}^{pess} < 0 \\ {E}_{t}^{pess} = {E}_{t - 1}^{pess} + {P}_{t}^{pess} {η}^{pch} Δ t , & {P}_{t}^{pess} \geq 0\end{matrix} , \qquad ( 6 )$$
$$∀ t ∈ T$$
$$\{ \begin{matrix}0 \leq {E}_{t}^{pess} \leq {E}_{t}^{pess , max} \\ {E}_{ini}^{pess} = {E}_{T}^{pess}\end{matrix} , \qquad ( 7 )$$
$$∀ t ∈ T$$
where Eₜ^{pess,max} is an upper limit of a state of charge for the port energy storage system; η^{pch} and η^{pdis} are respectively charging and discharging efficiencies of energy storage equipment of the port; Eₜ^{pess} represents a state of charge of the port energy storage system at the time period t; P^{pess,max} and P^{pess,min} are upper and lower limits of charging and discharging power of the port energy storage system; Eᵢₙᵢ ^{pess} is an initial capacity of the port energy storage system; and T is a total scheduling time period; and
the renewable energy source power generation system comprises a photovoltaic power generation system and a wind power generation system, and outputs Pₜ^{PV} and Pₜ^{WT} of the photovoltaic power generation system and the wind power generation system are allowed to be predicted and obtained in a short term by using historical data based on machine learning, where Pₜ^{PV} and Pₜ^{WT} respectively represent photovoltaic and wind power active outputs at the time period t.

6. The integrated operation method according to claim 1, wherein step S2 comprises:
step S2.1: establishing the optimized objective function of the port:
$$max \{ {\sum }_{t ∈ T} [ {\sum }_{i ∈ I} ( {c}_{p e , t}^{s} {P}_{i , t}^{c h} Δ t - {c}_{p e , t}^{b} {P}_{i , t}^{dis} Δ t ) - {c}_{t}^{gb} {P}_{t}^{gb} Δ t + {c}_{t}^{gs} {P}_{t}^{gs} Δ t - {C}_{t}^{DG} ] + {\sum }_{t ∈ {T}_{b}} {\sum }_{i ∈ I} {c}_{i , t}^{ser} Δ t \} \qquad ( 8 )$$
where [symbol] ₜ^{gb} and [symbol] ₜ^{gs} are respectively a price of electricity purchased by the port from a power grid and a price of electricity sold by the port at a time period t; Pₜ^{gb} and Pₜ^{gs} are respectively a quantity of electricity purchased from the power grid and a quantity of electricity sold at the time period t; T is an overall current scheduling operation time period; T_{b} is a port berthing time period of the ship; Δt is an optimized scheduling time interval; [symbol] _{ps,i,t} is a berthing service charge of an i^{th} ship at the time period t; [symbol] _{pe,t}^{s} and [symbol] _{pe,t}^{b} are respectively a charge of the port selling electricity to the ship and a charge of the port purchasing electricity from the ship at the time period t; P_{i,t}^{ch} and P_{i,t}^{dis} are respectively charging and discharging power of the i^{th} ship at the time period t; [symbol] _{i,t}^{ser} represents a service charge of the i^{th} ship at the time period t; and I represents an in-port ship set participating in a port and ship interaction;
step S2.2: establishing the optimized constraint condition of the port:
a port-ship energy transaction value constraint comprises:
$${c}^{lo} \leq {c}_{pe , t}^{b} \leq {c}_{pe , t}^{s} \leq {c}^{up} \qquad ( 9 )$$
where [symbol] ^{up} and [symbol] ^{lo} are upper and lower limits of an energy transaction price between the port and the ship;
a power equilibrium constraint:
$${\sum }_{i ∈ I} ( {P}_{i , t}^{ch} - {P}_{i , t}^{dis} ) + {P}^{pess} + {P}^{pl} = {\sum }_{n ∈ N} {P}_{n}^{DG} + {P}_{t}^{PV} + {P}_{t}^{WT} \qquad ( 10 )$$
where Pₜ^{pl} is a self-load of the port at the time period t;
step S2.3: establishing the optimized objective function of the ship:
$$min [ {\sum }_{t ∈ T} ( {c}_{pe , t}^{s} {P}_{i , t}^{ch} Δ t - {c}_{pe , t}^{b} {P}_{i , t}^{dis} Δ t ) + {\sum }_{t ∈ {T}_{b}} {c}_{ps , i , t} Δ t ] \qquad ( 11 )$$
where T is the overall current scheduling operation time period; T_{b} is the port berthing time period of the ship; Δt is the optimized scheduling time interval; [symbol] _{ps,i,t} is the berthing service charge of the i^{th} ship at the time period t; [symbol] _{pe,t}^{s} and [symbol] _{pe,t}^{b} are respectively the charge of the port selling electricity to the ship and the charge of the port purchasing electricity from the ship at the time period t; P_{i,t}^{ch} and P_{i,t}^{dis} are respectively the charging and discharging power of the i^{th} ship at the time period t; and
step S2.4: establishing the optimized constraint condition of the ship:
an energy storage related constraint for an all-electric ship is as follows:
$$\{ \begin{matrix}0 \leq {P}_{i , t}^{sch} \leq {P}_{i , t}^{sch , max} \\ 0 \leq {P}_{i , t}^{sdis} \leq {P}_{i , t}^{sdis , max} \\ {P}_{i , t}^{sch} {P}_{i , t}^{sdis} = 0 \\ {E}_{i , t + 1}^{s} = {E}_{i , t}^{s} + {η}^{sch} {P}_{i , t}^{sch} Δ t - \frac{{P}_{i , t}^{sdis}}{{η}^{sdis}} Δ t\end{matrix} \qquad ( 12 )$$
$$∀ t ∈ {T}_{b} ,$$
$$∀ i ∈ I$$
$${P}_{i , t}^{sch} {P}_{i , t}^{sdis} = 0 , \qquad ( 13 )$$
$$∀ t ∉ {T}_{b} ,$$
$$∀ i ∈ I$$
where T_{b} is the port berthing time period of the ship; Δt is the optimized scheduling time interval; I is a set of ships planned to arrive at the port; P_{i,t}^{sch} and P_{i,t}^{sdis} are respectively charging and discharging power of shipborne energy storage of the i^{th} ship at the time period t; P_{i,t}^{sch,max} and P_{i,t}^{sdis,max} are respectively upper limit values of the charging and discharging power of shipborne energy storage of the i^{th} ship at the time period t; E_{i,t}^{s} is a charged energy of shipborne energy storage of the i^{th} ship at the time period t; η^{sch} and η^{sdis} are respectively the charging and discharging efficiencies of shipborne energy storage; and P_{i,t}^{ch} and P_{i,t}^{dis} are respectively the charging and discharging power of the i^{th} ship at the time period t; and
a logistics related constraint is as follows:
assuming that loading and unloading rates of in-port ships of the port in the scheduling time periods are substantially consistent,
$${\sum }_{t ∈ {T}_{b}} {dl}_{i} = {S}_{i} , \qquad ( 14 )$$
$$∀ i ∈ N$$
where Sᵢ is a quantity of cargoes needed to be loaded and unloaded of the i^{th} ship, dlᵢ is a cargo loading and unloading rate of the i^{th} ship, and N is a set of the port diesel generators.

7. The integrated operation method according to claim 1, wherein S3 comprises:
S3.1: converting the port-and-ship layered game optimization model into a monolayer mixed integer linear model by using the Karush-Kuhn-Tucker optimality condition solving method; and
S3.2: then solving the monolayer mixed integer linear model by using a commercial solver to finally obtain an optimal energy transaction price strategy of the port.

8. An integrated operation system for a port-and-ship energy and transportation system based on a layered game, comprising:
a module M1, configured to formulate a layered game architecture for a port-and-ship integrated energy and transportation operation;
a module M2, configured to establish a port-and-ship layered game optimization model based on an optimized objective function and an optimized constraint condition of a port and an optimized objective function and an optimized constraint condition of a ship; and
a module M3, configured to, based on the port-and-ship layered game optimization model, solve, by the layered game architecture, to obtain an optimal integrated operation method for the port-and-ship energy and transportation system through a KKT optimality condition solving method;
wherein the port-and-ship layered game optimization model is configured to use the port as a superior guider to formulate and execute a strategy, use the ship as an inferior follower to make corresponding responses by taking the strategy formulated by the port as a constraint, and allow the port to update the strategy of the port according to the corresponding responses made by the ship till reaching a game equilibrium.

9. The integrated operation system according to claim 8, wherein in the module M1:
$$G = \{ ( P ⋃ S ) ; {s}_{p} ; {F}_{p} ; {s}_{s} ; {F}_{s} \} \qquad ( 1 )$$
where P represents energy supply equipment of the port; S represents a ship set; Sₚ represents a strategy set of a fixed microgrid of the port; Sₛ represents a strategy set of a mobile microgrid of the ship; Fₚ represents a net income realized by the strategy set of the fixed microgrid of the port; and Fₛ represents a net income realized by the strategy set of the mobile microgrid of the ship;
when the game equilibrium is reached, a utility function satisfies:
$${F}_{p} ( {s}_{p}^{*} , {s}_{s}^{*} ) \geq {F}_{p} ( {s}_{p} , {s}_{s}^{*} ) \qquad ( 2 )$$
$${F}_{s , i} ( {s}_{p}^{*} , {s}_{s , i}^{*} ) \geq {F}_{s , i} ( {s}_{p}^{*} , {s}_{s , ( - i )}^{*} , {s}_{s , i} )$$
F where F_{s,i} is the utility function of an i^{th} ship; and S*_{s,(-i)} is a charging and discharging * strategy set of other ships;
the strategy set Sₚ of the fixed microgrid of the port comprises active outputs of the energy supply equipment, a price of electricity sold by the port to the ship, and a price of electricity purchased by the port from the ship;
the strategy set Sₛ of the mobile microgrid of the ship represents a charging strategy and a discharging strategy of the ship;
the energy supply equipment of the port comprises a port diesel generator, a port energy storage system, and a renewable energy source power generation system;
the port diesel generator comprises:
$${C}_{t}^{DG} = {\sum }_{n ∈ N} {c}_{n , t}^{DG} {P}_{n , t}^{DG} , \qquad ( 3 )$$
$$∀ t ∈ T$$
$$\{ \begin{matrix}{P}_{n , t}^{DG} - {R}_{n , t}^{DG} \geq {γ}_{n , t} \cdot {P}_{n , min}^{DG} \\ {P}_{n , t}^{DG} - {R}_{n , t}^{DG} \geq {γ}_{n , t} \cdot {P}_{n , min}^{DG}\end{matrix} ,$$
$$∀ n ∈ N ,$$
$$∀ t ∈ T$$
$$\{ \begin{matrix}{P}_{n , t - 1}^{DG} - {P}_{n , t}^{DG} \leq {γ}_{n , t - 1} \cdot {RD}_{n} + {z}_{n , t} \cdot {SD}_{n} \\ {P}_{n , t}^{DG} - {P}_{n , t - 1}^{DG} \leq {γ}_{n , t - 1} \cdot {RU}_{n} + {y}_{n , t} \cdot {SU}_{n}\end{matrix} , \qquad ( 4 )$$
$$∀ n ∈ N ,$$
$$∀ t ∈ T$$
where RUₙ and RDₙ are respectively upper limits of a power increase range and a power decrease range of an n^{th} diesel generator; SDₙ and SUₙ are respectively power change values of the n^{th} diesel generator when starting and stopping; γ_{n,t} is a start-stop state indicating variable of the n^{th} diesel generator at a time period t; P_{n,min}^{DG} and P_{n,max}^{DG} are upper and lower limits of an active output of the n^{th} diesel generator; N is a port diesel generator set; T is an overall current scheduling operation time period; Cₜ^{DG} is a cost of the port diesel generator at the time period t; [symbol] _{n,t}^{DG} is an output cost coefficient of the port diesel generator; P_{n,t}^{DG} is an active output of the n^{th} diesel generator of the port at the time period t; R_{n,t}^{DG} represents a spinning reserve of a generator set; z_{n,t} represents a start indicating variable of the generator set; and y_{n,t} represents a stop indicating variable of the generator set;
the port energy storage system comprises:
$${P}^{pess , min} \leq {P}_{t}^{pess} \leq {P}^{pess , max} , ∀ t ∈ T \qquad ( 5 )$$
$$\{ \begin{matrix}{E}_{t}^{pess} = {E}_{t - 1}^{pess} - \frac{{P}_{t}^{pess}}{{η}^{pdis}} Δ t , & {P}_{t}^{pess} < 0 \\ {E}_{t}^{pess} = {E}_{t - 1}^{pess} + {P}_{t}^{pess} {η}^{pch} Δ t , & {P}_{t}^{pess} \geq 0\end{matrix} , \qquad ( 6 )$$
$$∀ t ∈ T$$
$$\{ \begin{matrix}0 \leq {E}_{t}^{pess} \leq {E}_{t}^{pess , max} \\ {E}_{ini}^{pess} = {E}_{T}^{pess}\end{matrix} , \qquad ( 7 )$$
$$∀ t ∈ T$$
where Eₜ^{pess,max} is an upper limit of a state of charge for the port energy storage system; η^{pch} and η^{pdis} are respectively charging and discharging efficiencies of energy storage equipment of the port; Eₜ^{pess}represents a state of charge of the port energy storage system at the time period t; P^{pess,max} and P^{pess,min} are upper and lower limits of charging and discharging power of the port energy storage system; Eᵢₙᵢ^{pess} is an initial capacity of the port energy storage system; and T is a total scheduling time period; and
the renewable energy source power generation system comprises a photovoltaic power generation system and a wind power generation system, and outputs Pₜ^{PV} and Pₜ^{WT} of the photovoltaic power generation system and the wind power generation system are allowed to be predicted and obtained in a short term by using historical data based on machine learning, where Pₜ^{PV} and Pₜ^{WT} respectively represent photovoltaic and wind power active outputs at the time period t.

10. The integrated operation system according to claim 8, wherein in the module M2:
a module M2.1, configured to establish the optimized objective function of the port:
$$max \{ {\sum }_{t ∈ T} [ {\sum }_{i ∈ I} ( {c}_{pe , t}^{s} {P}_{i , t}^{ch} Δ t - {c}_{pe , t}^{b} {P}_{i , t}^{dis} Δ t ) - {c}_{t}^{gb} {P}_{t}^{gb} Δ t + {c}_{t}^{gs} {P}_{t}^{gs} Δ t - {C}_{t}^{DG} ] + {\sum }_{t ∈ {T}_{b}} {\sum }_{i ∈ I} {c}_{i , t}^{ser} Δ t \} \qquad ( 8 )$$
where [symbol] ₜ^{gb} and [symbol] ₜ^{gs} are respectively a price of electricity purchased by the port from a power grid and a price of electricity sold by the port at a time period t; Pₜ^{gb} and Pₜ^{gs} are respectively a quantity of electricity purchased from the power grid and a quantity of electricity sold at the time period t; T is an overall current scheduling operation time period; T_{b} is a port berthing time period of the ship; Δt is an optimized scheduling time interval; [symbol] _{ps,i,t} is a berthing service charge of an i^{th} ship at the time period t; [symbol] _{pe,t}^{s} and [symbol] _{pe,t}^{b} are respectively a charge of the port selling electricity to the ship and a charge of the port purchasing electricity from the ship at the time period t; P_{i,t}^{ch} and P_{i,t}^{dis} are respectively charging and discharging power of the i^{th} ship at the time period t; [symbol] _{i,t}^{ser} represents a service charge of the i^{th} ship at the time period t; and I represents an in-port ship set participating in a port and ship interaction;
a module M2.2, configured to establish the optimized constraint condition of the port:
a port-ship energy transaction value constraint comprises:
$${c}^{lo} \leq {c}_{pe , t}^{b} \leq {c}_{pe , t}^{s} \leq {c}^{up} \qquad ( 9 )$$
where [symbol] ^{up} and [symbol] ^{lo} are upper and lower limits of an energy transaction price between the port and the ship;
a power equilibrium constraint:
$${\sum }_{i ∈ I} ( {P}_{i , t}^{ch} - {P}_{i , t}^{dis} ) + {P}^{pess} + {P}^{pl} = {\sum }_{n ∈ N} {P}_{n}^{DG} + {P}_{t}^{PV} + {P}_{t}^{WT} \qquad ( 10 )$$
where Pₜ^{pl} is a self-load of the port at the time period t;
a module M2.3, configured to establish the optimized objective function of the ship:
$$min [ {\sum }_{t ∈ T} ( {c}_{pe , t}^{s} {P}_{i , t}^{ch} Δ t - {c}_{pe , t}^{b} {P}_{i , t}^{dis} Δ t ) + {\sum }_{t ∈ {T}_{b}} {c}_{ps , i , t} Δ t ] \qquad ( 11 )$$
where T is the overall current scheduling operation time period; T_{b} is the port berthing time period of the ship; Δt is the optimized scheduling time interval; [symbol] _{ps,i,t} is the berthing service charge of the i^{th} ship at the time period t; [symbol] _{pe,t}^{s} and [symbol] _{pe,t}^{b} are respectively the charge of the port selling electricity to the ship and the charge of the port purchasing electricity from the ship at the time period t; P_{i,t}^{ch} and P_{i,t}^{dis} are respectively the charging and discharging power of the i^{th} ship at the time period t; and
a module M2.4, configured to establish the optimized constraint condition of the ship:
an energy storage related constraint for an all-electric ship is as follows:
$$\{ \begin{matrix}0 \leq {P}_{i , t}^{sch} \leq {P}_{i , t}^{sch , max} \\ 0 \leq {P}_{i , t}^{sdis} \leq {P}_{i , t}^{sdis , max} \\ {P}_{i , t}^{sch} {P}_{i , t}^{sdis} = 0 \\ {E}_{i , t + 1}^{s} = {E}_{i , t}^{s} + {η}^{sch} {P}_{i , t}^{sch} Δ t - \frac{{P}_{i , t}^{sdis}}{{η}^{sdis}} Δ t\end{matrix} \qquad ( 12 )$$
$$∀ t ∈ {T}_{b} ,$$
$$∀ i ∈ I$$
$${P}_{i , t}^{sch} {P}_{i , t}^{sdis} = 0 , \qquad ( 13 )$$
$$∀ t ∉ {T}_{b} ,$$
$$∀ i ∈ I$$
where T_{b} is a port berthing time period of the ship; Δt is an optimized scheduling time interval; I is a set of ships planned to arrive at the port; P_{i,t}^{sch} and P_{i,t}^{sdis} are respectively charging and discharging power of shipborne energy storage of the i^{th} ship at the time period t; P_{i,t}^{sch,max} and P_{i,t}^{sdis,max} are respectively upper limit values of the charging and discharging power of shipborne energy storage of the i^{th} ship at the time period t; E_{i,t}^{s} is a charged energy of shipborne energy storage of the i^{th} ship at the time period t; η^{sch} and η^{sdis} are respectively the charging and discharging efficiencies of shipborne energy storage; and P_{i,t}^{ch} and P_{i,t}^{dis} are respectively the charging and discharging power of the i^{th} ship at the time period t; and
a logistics related constraint is as follows:
assuming that loading and unloading rates of the in-port ships of the port in the scheduling time periods are substantially consistent,
$${\sum }_{t ∈ {T}_{b}} {dl}_{i} = {S}_{i} , \qquad ( 14 )$$
$$∀ i ∈ N$$
where Sᵢ is a quantity of cargoes needed to be loaded and unloaded of the i^{th} ship, dlᵢ is a cargo loading and unloading rate of the i^{th} ship, and N is a set of the port diesel generators;
the module M3 comprises:
a module M3.1, configured to convert the port-and-ship layered game optimization model into a monolayer mixed integer linear model by using the Karush-Kuhn-Tucker optimality condition solving method; and
a module M3.2, configured to, then solve the monolayer mixed integer linear model by using a commercial solver to finally obtain an optimal energy transaction price strategy of the port.
